(19) United States
(12) Patent Application Publication
(10) Pub. No.: US 2016/0070702 A1
(43) Pub. Date: Mar. 10, 2016

(54) METHOD AND SYSTEM TO ENABLE USER RELATED CONTENT PREFERENCES INTELLIGENTLY ON A HEADPHONE

(71) Applicant: Aivvy Inc., San Mateo, CA (US)

(72) Inventors: Xiaodong MAO, Foster City, CA (US); Xianghui MAO, shang (CN)

(21) Appl. No.: 14/848,327

(22) Filed: Sep. 8, 2015

Related U.S. Application Data
(60) Provisional application No. 62/048,145, filed on Sep. 9, 2014.

(51) Int. Cl. G06F 17/30; G06F 3/0482; H04L 29/08

(52) U.S. Cl. CPC G06F 17/30038; H04L 67/306; H04L 67/06; G06F 17/30598; G06F 3/0482

(57) ABSTRACT

A Method and System to enable user related content preferences intelligently on a headphone is disclosed. The embodiments relate generally to the field of user related content preferences. The embodiments are directed at controlling the content preference data so that a music cortex functions as a data agency to provide the music devices, music applications and streaming services smarter choices and intelligent recommendations.

### TECHNICAL FIELD

Embodiments of the disclosure relate generally to the field of user related content preferences. Embodiments relate more particularly to controlling the content preference data so that a music cortex functions as a data agency to provide the music devices, music applications and streaming services smarter choices and intelligent recommendations.

### BACKGROUND

The rapid growth of personal entertainment devices has resulted in them becoming a handy tool for millions of consumers. Due to their highly portable nature and ease of connectivity with the internet, consumers use these devices to download music and other types of electronic media in a simplistic manner.

The computing devices widely vary with respect to size, cost, amount of storage and processing power. Several portable devices have come a long way in terms of processing power and computational abilities thus providing the user with digital interfaces, extreme audio and video clarity, and high internet connection speed. These advances in computing allows the user to take full advantage of these portable devices, since most of them use it in a way very similar to their personal computer. One of the popular portable devices includes audio entertainment devices which have developed by leaps and bounds since the days of the Sony Walkman portable music player.

Currently, we have the latest versions of iPod music players and other jukebox players which can store millions of songs in multiple numbers of playlists. Although, the computational ability and storage power of these devices continue to grow, music players do not seem to take into account the user's preferences depending upon a variety of factors, thus depriving him/her of an option of automatically listening to his/her preferred content. Users are therefore still dependent on manual selections and pre-configured playlists, which do not take into account the parameters affecting a user's musical listening preferences.

In the light of the above discussion, there appears to be a need for an intelligent user device with intuitive controls which automatically gather's user preferences on a real time basis and plays the content.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a high-level block diagram depicting the architectural distinction of the intelligent headphone, according to the embodiments as disclosed herein;

FIG. 2 is a block diagram of the intelligent headphone, according to the embodiments as disclosed herein;

FIG. 3 is a screenshot depicting an example implementation of the Intelligent Headphone, according to the embodiments as disclosed herein;

FIG. 4 depicts the predictive programming modules of the Intelligent Headphone, according to the embodiments as disclosed herein; and

FIG. 5 is a block diagram of a machine in the example form of a computer system 500 within which instructions for causing the machine to perform any one or more of the methodologies discussed herein may be executed.

### DETAILED DESCRIPTION OF THE EMBODIMENTS

The above-mentioned needs are met by a method and system for enabling an intelligent headphone to control the music preference data and sharing between music sources. The following detailed description is intended to provide example implementations to one of ordinary skill in the art, and is not intended to limit the invention to the explicit disclosure, as one or ordinary skill in the art will understand that variations can be substituted that are within the scope of the invention as described.

The overall system of the Music cortex is divided in terms of front (local) and back (remote, cloud-based elements). The method of the present subject matter includes storing a set of digital music files in a computer-readable storage medium on a back-end server. Each digital audio file is associated with one or more audio identifiers. The method also includes providing an Application Programming Interface (API) for client systems remote from the back end servers to retrieve a list of the set of one or more digital audio files. The method also includes providing, to one or more front-end servers remote from the back-end server, computer network address information for accessing the API. Each of the one or more front-end servers is associated with one or more of the one or more audio identifiers.

As used herein, the term “cortex” is adapted, metaphorically, from its formal definition as the outer layer of the cerebrum (the cerebral cortex) of the human brain, composed of folded gray matter and playing an important role in memory, attention, perception, awareness, thought, language, and consciousness. The present cortex, as a computer-implemented system or method, is employed so as to play a comparably important role in understanding the tastes and preferences of users as to various multimedia or other data items, and in employing that understanding to select, from a library of such data items, other data items which the user is also likely to favor. The data items are classified by classification parameters, to give the cortex a basis for comparing and correlating the values of the classification parameters, and for inferring and predicting user preference based on the correlation of the classification parameter values.

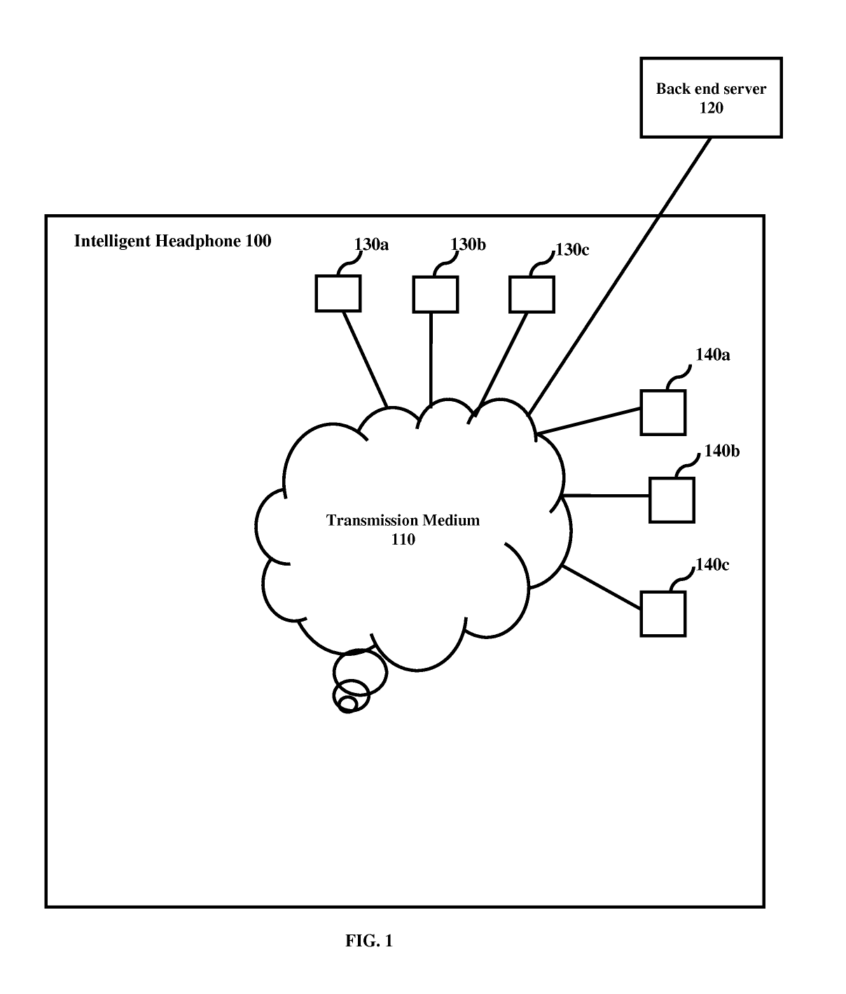

FIG. 1 is a block diagram depicting the architectural distinction of the intelligent headphone, according to the embodiments as disclosed herein.

As depicted in FIG. 1, a Intelligent Headphone 100 includes a Transmission Medium 110, one or more Front-End servers 130a, 130b, and/or 130c, generally 130 and/or one or more client systems 140a, 140b and/or 140c, generally 140. The Transmission Medium 110 is connected to a Back-End Server 120 residing outside the Intelligent Headphone 100 and is responsible for the transfer of information between one or more of the Back-End Servers 120, one or more of the Front-End Server 130, and/or one or more of the Client Systems 140.

The Servers 120 and 130 can include, for example, web servers, application servers, media servers, and/or other software/hardware system that provides services to remote clients. The Front-End Servers 130 can include websites operated, managed, and/or controlled by musical artists, composers, fans, publishers, and/or record companies. For example, in some embodiments the Front End Server 130 may host a website for a musical group). As described in more detail below, the Back End Server 120 can be responsible for providing music services (e.g., previewing music and/or downloading music) to consumer(s) using remote client system(s) 140 via the Front-End servers 130.

In some embodiments, an Application Programming Interface (API) is provided on the Back-End Server 120 for the Remote Client System 140 to request and retrieve digital-audio files stored on the Back-End Server 120. The API includes a set of rules and specifications that a software application uses to access the music services. The software application can be executed on one of the Front-End Servers 130 and/or directly on one of the Remote Client System 140. In some embodiments, the API is a web interface conforming to the Representational State Transfer (REST) architecture. In alternative or supplemental embodiments, the API is a web interface conforming to the Simple Object Access Protocol (SOAP).

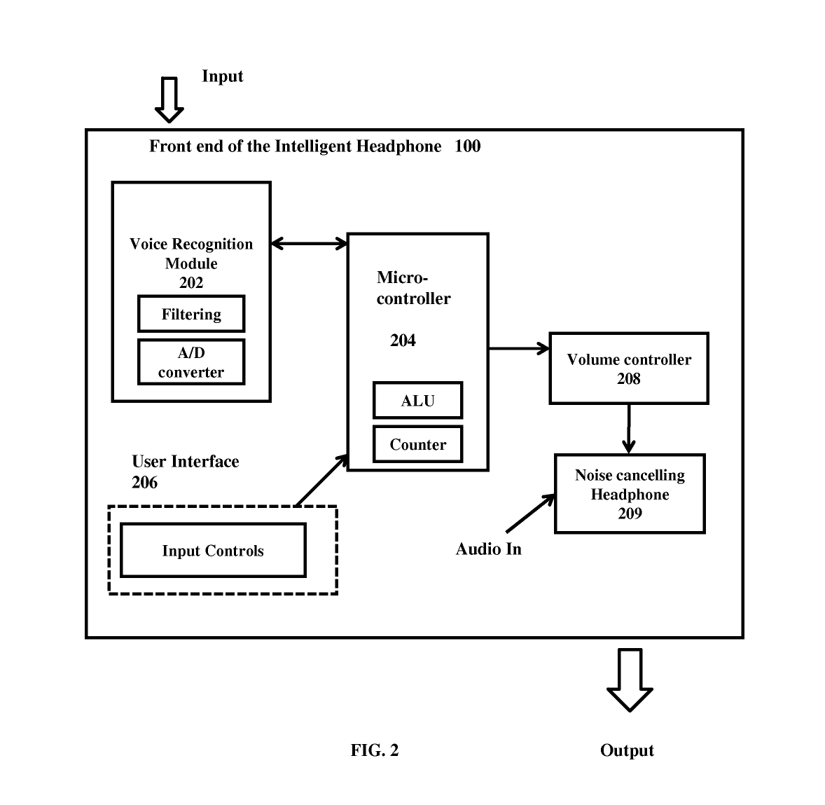

FIG. 2 is a block diagram of the front end of the Intelligent Headphone, according to the embodiments as disclosed herein. As depicted in FIG.2, the front end of the Intelligent Headphone 100 comprises of a Voice Recognition Module 202, a User Interface 206, a Micro-controller 204, a Volume controller 208 and a Noise cancelling headphone 205.

Network link(s) involved in the Intelligent Headphone 100 may include any suitable number or arrangement of interconnected networks including both wired and wireless networks. By way of example, a wireless communication network link over which mobile devices communicate may utilize a cellular-based communication infrastructure or wireless mesh networks. The communication infrastructure includes cellular-based communication protocols such as LTE, AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Blue-Tooth.

In an embodiment, the Intelligent Headphone 100 is a headphone which is configured to intelligently make user recommendations and play content based on user's location, mood, preferences, and other related factors. While the present embodiment has the physical morphology of a headset, other embodiments, within the spirit and scope of the present subject matter, may take other forms which would suitably meet the user's needs as described herein.

In an embodiment, content is defined as any media-related content which can be played on the Intelligent Headphone 100 and is not limited to audio-related content.

The Intelligent Headphone 100 may be operably connected with (or included within) an enterprise network. The Enterprise network may further include one or more of email or exchange servers, enterprise application servers, internal application store servers, authentication (AAA) servers, directory servers, Virtual Private Network (VPN)/SSL gateways, firewalls, among other servers and components. Email or exchange servers may include Exchange Active Sync (EAS) or other functionality that provides synchronization of contacts, calendars, tasks, and email between Active sync enabled servers and mobile devices. Other synchronization products can also be used. The mobile devices may access or utilize one or more of these enterprise systems or associated functionality.

In certain embodiments, the server and/or the mobile development service may be hosted and operated by one or more third-party service providers, and/or may be accessed by developers through a communication network using a suitable network interface device such as a developer computer. In certain embodiments, the network may be any suitable type of wired and/or wireless network, such as an Internet network or dedicated network that allows developers to access the Intelligent Headphone 100 through the developer computer.

Developers may access the Intelligent Headphone 100 by navigating to one or more web pages using for example a standard web browser on developer computer, thereby obviating the need to download and/or install separate software on a developer computer. In certain other embodiments, the Intelligent Headphone 100 system may be a separate client or stand-alone mobile device software application that can be downloaded by developers from server and/or one or more other third-party servers, or may be provided to developers through any other suitable means (e.g., CD, physical disk, etc.) and installed on a developer computer.

The components within the front end of the Intelligent Headphone 100 of FIG. 1 will now be described. The Voice Recognition Module 202 is a multi-purpose speech recognition module designed to add versatile, robust and cost effective speech and voice recognition capabilities. The Voice Recognition Module 202 captures sounds, performs noise filtering, converts the analog signal to digital signal, and communicates with the Arduino Nano for example.

As depicted in FIG. 1, the User Interface (UI) module 206 may also include a display device, a processor accessible memory, or any device or combination of devices to which data is output. The UI module 206 interfaces with the Microcontroller 204 to obtain the captured data in real time. The User interface 206 is mainly classified into three types, which are the hardware interface, voice interface and the visual interface. The hardware interface includes any component of the Intelligent Headphone 100 which comes into contact with the user, and could be in the form of power switch or reset switch.

The voice interface does not have physical contact with the user, and it requires only sound as an input. The visual interface does not have physical contact with the user, and its main purpose is to indicate to the user the different modes of operation. The visual interface may include a dedicated graphics processor and memory to support the displaying of graphics intensive media.

In an embodiment, a sensor interface is provided which allows one or more sensors to be operatively coupled to the User Interface 206. Some of the sensors may be installed within the case housing of the Intelligent Headphone 100.

The Micro-controller 204 is provided to interpret and execute logical instructions stored in the main memory. The main memory is the primary general purpose storage area for instructions and data to be processed by the central processor.

The Noise cancelling headphone 209 avoids interference from external noise and comprises a high powered digital amplifier for decreasing distortion.

For example, users may access the Intelligent Headphone 100 using a special-purpose client application hosted by a device of the user (or a web- or network-based application using a browser client). The client application may automatically access Global Positioning System (GPS) or other geolocation functions supported by the device.

In particular embodiments, the Intelligent Headphone 100 include a processor, memory, storage, an input/output (I/O) interface, a communication interface, and a bus. In particular embodiments, processor includes hardware for executing instructions, such as those making up a computer program. As an example and not by way of limitation, to execute instructions, processor may retrieve (or fetch) the instructions from an internal register, an internal cache, memory, or storage; decode and execute them; and then write one or more results to an internal register, an internal cache, memory, or storage. In particular embodiments, the processor may include one or more internal caches for data, instructions, or addresses. In particular embodiments, the memory includes main memory for storing instructions for the processor to execute data for the processor to operate on. As an example and not by way of limitation, the Intelligent Headphone 100 may load instructions from the storage to the memory. The Processor may then load the instructions from memory to an internal register or internal cache. To execute the instructions, the processor may retrieve the instructions from the internal register or internal cache and decode them. During or after execution of the instructions, the processor may write one or more results (which may be intermediate or final results) to the internal register or internal cache. Processor may then write one or more of those results to memory. One or more memory buses (which may each include an address bus and a data bus) may couple processor to memory. Bus may include one or more memory buses, as described below. In particular embodiments, one or more memory management units (MMUs) reside between processor and memory and facilitate accesses to memory requested by the processor. In particular embodiments, memory includes random access memory (RAM). This RAM may be volatile memory, where appropriate, this RAM may be dynamic RAM (DRAM) or static RAM (SRAM).

In particular embodiments, storage includes mass storage for data or instructions. As an example and not by way of limitation, storage may include a HDD, flash memory, an optical disc, a magneto-optical disc, magnetic tape, or a Universal Serial Bus (USB) drive or a combination of two or more of these. Storage may include removable or non-removable (or fixed) media, where appropriate. Storage may be internal or external to computer system, where appropriate. In particular embodiments, storage is non-volatile, solid-state memory. In particular embodiments, storage includes read-only memory (ROM). Where appropriate, this ROM may be mask-programmed ROM, programmable ROM (PROM), erasable PROM (EPROM), or flash memory or a combination of two or more of these.

In particular embodiments, an input/output I/O interface includes hardware, software, or both providing one and more interfaces for communication between Intelligent Headphone 100 and one or more I/O devices. The Intelligent Headphone 100 may include one or more of these I/O devices, where appropriate. One or more of these I/O devices may enable communication between a person and Intelligent Headphone 100. As an example and not by way of limitation, an I/O device may include a keyboard, microphone, display, touch screen, mouse, speaker, camera, another suitable I/O device or a combination of two or more of these. An I/O device may include one or more sensors. This disclosure contemplates any suitable I/O devices and any suitable I/O interfaces for them. Where appropriate, I/O interface may include one or more device or software drivers enabling the processor to drive one or more of these I/O devices. I/O interface may include one or more I/O interfaces, where appropriate. Although this disclosure describes and illustrates a particular I/O interface, this disclosure contemplates any suitable I/O interface.

In particular embodiments, the communication interface includes hardware, software, or both providing one or more interfaces for communication (such as, for example, packet-based communication) between computer system and one or more other computer systems or one or more networks. As an example and not by way of limitation, the communication interface may include a network interface controller (NIC) for communicating with an Ethernet or other wire-based network or a wireless NIC (WNIC) for communicating with a wireless network, such as a WI-FI network. This disclosure contemplates any suitable network and any suitable communication interface for it. As an example and not by way of limitation, the Intelligent Headphone 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the Intelligent Headphone 100 may communicate with a wireless PAN (WPAN) (e.g., a BLUETOOTH WPAN), a WI-FI network (e.g., a 802.11a/b/g/n WI-FI network), a WI-MAX network, a cellular telephone network (e.g., a Global System for Mobile Communications (GSM) network, a Long Term Evolution (LTE) network), or other suitable wireless network or a combination of two or more of these.

The client-side functionality described above can be implemented as a series of instructions stored on a computer-readable storage medium that, when executed, uses a programmable processor to implement the operations described above.

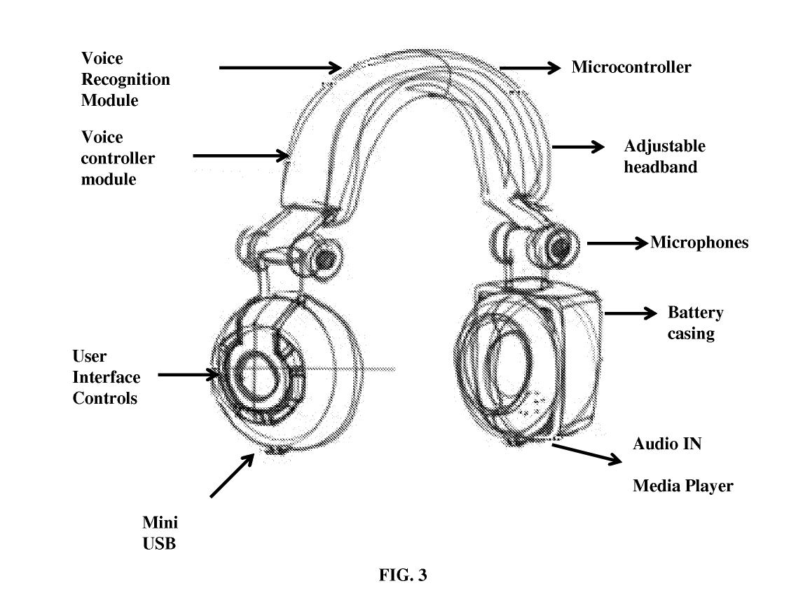

FIG. 3 is a screenshot depicting an example implementation of the Intelligent Headphone, according to the embodiments as disclosed herein. As depicted in FIG. 2, the Intelligent Headphone 100 includes the Voice recognition module 202, the Micro-controller 204, a Volume controller module 208, one or more user interface buttons, an adjustable headband, microphones and a battery casing.

The Intelligent Headphone 100 provides for the playback and recording of digital media, for example, multi or multimedia encoded in formats such as MP3, AVI, WAV, MPG, QT, WMA, AIFF, AU, RAM, RA and so on. The Intelligent Headphone 100 includes a microphone input port and a headphone or speaker output port. Additionally, the Intelligent Headphone 100 optionally includes features such as graphic equalization, volume, balance, fading, base and treble controls, and noise reduction.

In a preferred embodiment, a predictive analysis program is loaded and programmed to monitor behavioural aspects of music media file selection by a user along with the sensor data collected from a plurality of sensors to determine aspects of relevance and correlation between a user's file selection preferences, location and mood related multimedia information to intelligently predict which music files under a given set of circumstances will most likely be desired to be played by the user at that particular point of time.

The present subject matter enables the Intelligent Headphone 100 to select, suggest and/or play a musical media file that the user is more likely to be in the state of mind to listen to as compared to a music media file selected purely at random. Storing user related data over a certain duration of time to relate to user's past media file selections and statistically correlating the selections with chronographic, meteorological, geo-spatial, physiological and/or behavioural ambient factors of the user at the time these choices are made.

The present subject matter includes a data archival process for collecting and storing chronographic information, sensor data, schedule data, physical cues each time the user expresses a musical selection or preference and correlating this data with the musical selection or preference that was expressed and a predictive media file selection routine which selects a particular media file from a plurality of music files stored in the database.

The sensors described in the embodiments herein include but are not limited to air temperature sensors, skin temperature sensors, light-level sensors, pulse rate sensors, GPS positioning sensors, accelerometer sensors, motion sensors and/or a combination thereof. User preferences includes for example, a user's interactions and personal preferences associated with the Intelligent Headphone 100 such as music media file selections, volume settings, display brightness settings, sound balance and so on.

User preference may be ascertained either (i) directly, by means of receipt of user interactions and sensory reactions as just described, or (ii) by inference and prediction, based on comparison and correlation of classification parameter values between the user's history of preferences and the values of a given data item. In an embodiment, these two ways of ascertaining user preference may be weighted or ranked. For instance, an assumption may be made that the manual music media file selection by the user (i, above) is more indicative of a user's personal music preferences than an automated music media file selection (ii, above). Thus, the correlation between the selection of a particular music media file and the historical ambient influence information is considered to be weaker when it is the result of an automated music media file selection. Also, such a weighting or ranking may vary over time, if the user's taste or mood at a given time is different from what the user's taste or preference might have been at another time.

In another embodiment, if the Intelligent Headphone 100 is configured to automatically play the retrieved music media file, the music media file begins playing automatically after the currently playing music media file has finished. Alternately, if the Intelligent Headphone 100 is configured to suggest the selected music media file, the user is prompted to accept the suggested music media file.

In one embodiment of the present subject matter, the data relating to usage patterns of the user is stored, wherein the data includes information as to items which were used and the context in which they were used. In another embodiment, a system for making recommendations to a user is provided, the system includes means for storing data relating to usage patterns of the user, wherein the data includes information as to items which were used and the context in which they were used.

Further, the predictive analysis program may be automatically recommended to the user based on data related to the current context and past usage information. The context refers to the situation in which the user and/or device the user is operating. For example, the context may include the location/mood of a user whether the user is at home, at the office or elsewhere. The context may also include the time of the day or the mood of the user. One of ordinary skill in the art will recognize that there may be many other types of information captured by context and the specification shall not be seen as limiting the present subject matter to any particular type of information.

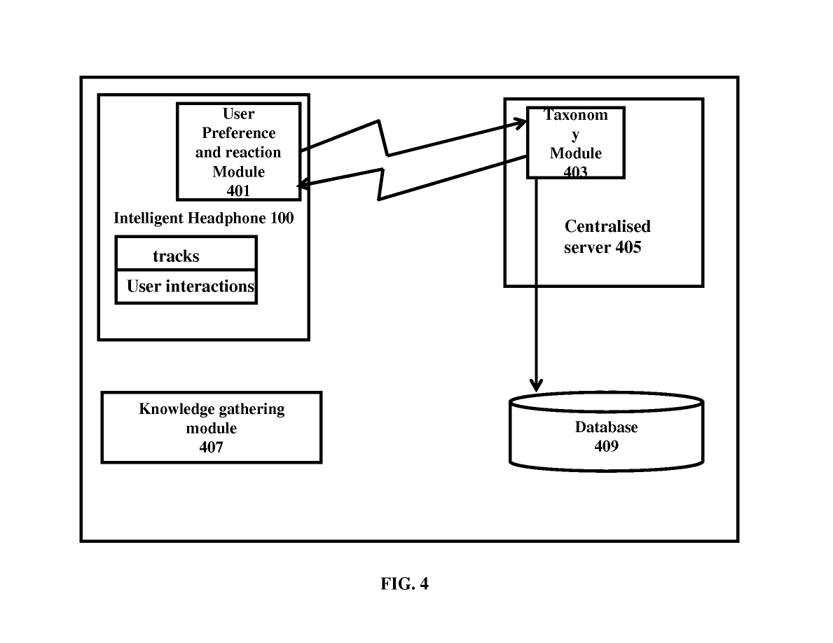

FIG. 4 depicts the predictive programming modules of the front end of the Intelligent Headphone 100, according to the embodiments as disclosed herein. As depicted in FIG. 4, the Intelligent Headphone 100 comprises of a User Preference and reaction module 401, a Taxonomy module 403, a Centralised server 405, a Knowledge gathering module 407 and a Database 409.

Essentially, the User Interface 106 of FIG. 1 comprises an internal cache which is configured to manage and recommend units of multimedia information (music, audio) from the cloud and offline sources. The UI 106 is configured to receive indicia of favorable user reaction to the units of multimedia information. The User Preference and Reaction module 401 is configured to determine user preferences which are determined by gaining knowledge about the user. The User Preference and Reaction module 401 is configured for determining user preference of units of multimedia information based on the Taxonomy module's 403 for classifying the units of multimedia information according to a predetermined set of classification parameters.

The terms “multimedia information,” “data item,” and “information,” used throughout the specification, are intended to cover all types of multimedia and other playable content on the Intelligent Headphone 100. The Taxonomy Module 403 is used to classify several units of multimedia information according to a predetermined set of classification parameters. The multimedia information can variously include its acoustic features (beats, tempo, keys, genre, etc.), and other types of audio information such as music, speech, and sound effects. The multimedia information further can include its social features; for instance, if a user searched/purchased/liked a given song or artist or album, what other songs/artists/albums this user also searched/purchased/liked, so as to classify the statistic similarity among artists/tracks/albums. The multimedia information can also include visual information such as video, still images, graphics, and displayed text or other symbols. Thus, embodiments of the present subject matter may include classification parameters suitable for any of these categories of multimedia content.

As used herein, the term “social features” and the like is defined as user preference data which employs preferences from other users which may be compared and correlated with the user's preferences for selecting data items for downloading, caching and playback to the user. Rather than merely employing correlated values for classification parameters given by the user's previously selected preferences, social data additionally employs such data from other users. Accordingly, a given user may be inferred to be interested in certain other data items having a given set of classification parameter values, even though the user's history of preferences may not be complete enough to show such preferences, where other users whose preferences correlate well with the user's preferences do in fact show a preference for such other data items. The preference data from other users may be obtained by known techniques such as data mining.

For example, the Taxonomy Module 403 can classify several categories of music genre files ranging from soft rock, jazz, blues and reggae, and musicians in categories such as classic, retro and modern. It can also classify based on beats per minute (BPM) and key most commonly. Various instrumental or vocal artists, for instance singers such as Frank Sinatra, Elvis Presley and Miley Cyrus may fall into such categories. Classification may also be based on music theory concepts such as circle-of-5^{th}, harmonic mixing, instrumentation, forms (for instance, two-part song form, sonata form, rondo form, fugue, ritornello, etc.), tonalities and key relationships, scales or modes, harmonic complexity, polyphonic/harmonic texture, dynamic range, etc.

The classification may also depend on its social features in state-of-art music recommendation theory. For instance, the popular artists Celine Dion, Mariah Carey, George Michael may be considered to be socially similar, since, if a user likes Celine Dion, most likely this user also likes Mariah Carey or George Michael. Social similarity may be determined by mining global or multiple user data collected from search sites (such as Google), shopping sites (amazon), catalogues (Lost.fm), twitter (detect music trend most twitter users discussed), Facebook (what's your friends their favorite music), and Billboard (what is popular now)

In an embodiment, taxonomy classification can be based on feature vectors whose elements are either statistical measures of short time, frame based features across long term windows, measures describing the rhythmic properties of the excerpt, or social similarity (for instance, for clusters of users who likes a given song, what other songs this user group likes) A feature vector may broadly be described as an ordered set of values for respective parameters. A parameter, within such a feature vector, may be any one of the foregoing classification parameters which may be characterized in some quantitative fashion. For instance, a dynamic range parameter might have a numeric value which is low for audio information which remains at a relatively constant dynamic (loudness) throughout, or high for audio information which varies in loudness drastically. As an alternative to comparing such numeric values, another embodiment may employ mean/standard deviation measures of statistic distances, such as the Mahalanobis distance, between social clusters. A parameter might alternatively have a non-numerical value, such as a set of character-string values. For example, the parameter might give the form of the piece of music, selected from a set of possibilities such as those given above.

When feature vectors are used for determining user preference, it may be the case that the user's preference correlates more strongly with some feature vector parameters, than with others. The parameter values may be weighted accordingly. For instance, if the user prefers soft background music, then a feature vector parameter of dynamic range might indicate a strong preference for low dynamic range, giving the user the ability to set a low playback volume, whereas other parameters such as music genre, artists, or musical forms might be of lesser importance to the user.

Additionally, given a subset of genres with their corresponding training data, the algorithm used in the embodiments herein selects out the full list of available features that maximize genre separability. The term “training,” as used here, refers to the process of developing a system's ability to deduce correct answers from bodies of input data by setting values of the system's configuration parameters. A system is trained by inputting to it data for which the answer is known, and then setting the configuration parameters within the system, so as to lead the system toward the correct answer. If this training is done using a good-quality set of training data, then the system will be able to deduce similarly good quality answers when actual data is fed into it. For example, neural network technology may be so employed. Multiple layers of electronic or digitally simulated neurons receive weighted signals from neurons within the previous layer, or from inputs. The output of a given neuron is a function of the weighted values of its inputs. In training, the weight values are adjusted so that the output of the final layer of neurons gives the desired answer.

In a preferred embodiment, the Intelligent Headphone 100 is configured to operate independently of an external device, and is capable of directly streaming music or other audio from the cloud and other offline sources. The Intelligent Headphone 100 comprises one or more intuitive controls and a learning algorithm that customizes audio recommendations based on the user's habits, including the use of headphones in physical space. The intuitive controls can include but not be limited to finger gestures and motion sensors. For example, the finger gesture can include forward gestures which indicates skipping of a track and a backward gesture can indicate replaying of a song. Double tapping on the UI 206 can signify that the track is one of the user's favorites whereas long pressing on the UI 206 may signify that the track need not be played again. Further, the intuitive controls can also include motion sensors to detect head motion such as nodding indicating favorite songs, still head motion indicating neutral and so on.

In addition, the motion sensor also forms a part of the intuitive controls and are configured to detect how fast one is walking, running or travelling. The ECG sensor detects the heartbeat which is usually in the range of 120 to 150 Beats per Minute bpm. Less than 120 bpm indicates that the user is not exercising hard enough and greater than 150 bpm indicates that the user is reaching his body limit during exercising where different audio tracks are played based on the heartbeat and motion pace. For example, if the user is walking at a gentle pace then a soft number by the artist Phil Collins can be played and in case the user is running hard then a peppy number by the rapper Eminem may be played by the Intelligent Headphone 100.

The Intelligent Headphone 100 is capable of autonomous and intelligent management of audio content independent of a streaming network connection or an external device. The Intelligent Headphone 100 comprises a separate low-power consuming Bluetooth Low Energy network chip used for activities such as a long-term period with a always—on “sleep and wake” functionality, autoplay functionality that passively detects when the user puts on the headphones and automatically begins playing audio. Further, the Intelligent Headphone 100 facilitates communication to proprietary backend cloud servers for location-finding and identification and customer support and diagnostics of the device, and stores the data in the Database 409 capable of storing thousands of audio content.

In an embodiment, an on-board cache in the Database 409 comprises a huge library of songs where the user can choose songs whose parameters match the user's profile and preferences as well as those that the system might download into the Database 409. In case the user selects a non-cached song then the Intelligent Headphone 100 has to stream the song on the spot. However, the Intelligent Headphone 100 can sometimes predict and download in advance what the user might prefer, where the user can control the music preference data and the sharing between music sources (audio streaming services). This is possible when the user registers for an account and once the account is registered, the user data is anonymously stored to help develop a history on the user's usage and preferences and in turn make best recommendations. The Music cortex can also act independently of the Back End Server 120, noting the user's preferences and making up to the minute recommendations. This data is eventually reported back to the servers for long term historical tracking and refinement.

The Music cortex of the embodiments herein acts as a data agency to give the music devices, music applications and streaming services smarter choices and intelligent recommendations. The algorithm behind the Music cortex is an application of Graph theory on Music data, plus the contextual information that is captured from the user's environment and kinetic data. So all the data above is composed into a node/edge relationship and is eventually described as a neural network. For example, if a user wants to listen to Metallica's “Nothing else matters” three times, he taps the “like” button on a music player where the Music cortex records such multimedia information to generate a dataset including all possible metadata of the song such as (1990's, Heavy Metal, Thursday evening) also with different contextual information (Starbucks, Moody) combined into the metadata to form a stimulation data set. This dataset is then uploaded to the Backend Server 120 where the historical data the user has generated resides. Thus, the new dataset will be added up to the original dataset to form a larger dataset. The learned behaviors are continually being measured and evolved as a form of intelligent caching.

In an embodiment, the Intelligent Headphone 100 is configured to use a Wi-Fi access point and motion sensors (such as a gyroscope, accelerometer and a digital compass) to locate the Headphone 100 in-house (without GPS, signal and so on). Further, Wi-Fi access points assists in triangulating motion sensors so as to provide fine granularity.

Another aspect is that a playlist need not contain each song only once, but may instead contain certain songs more than once. The frequency of occurrence may be based on various data, such as how similar a song is to the song being played or user-provided attributes, personal popularity, current popularity, user interaction, and so on. A shuffling mechanism can ensure that a song is not replayed too often.

Users can preview the recommended songs and interact with them such as to remove a recommended song if disliked or drag a song to the waiting queue. Such interactions implicitly show the user's preference at this moment in time, whereby the recommended playlist may be automatically adjusted based on these interactions.

### Back-End Server—Content File Storage

In an embodiment, Digital-print files stored on the Back End Server 120 include information that is used to visually display symbols, which represent aurally perceived music, on paper and/or, on a computer visual display device. Examples of musical symbols include lines (e.g., staff, bar lines), clefs (e.g., bass clef), notes and rests (e.g., quarter note), accidentals (e.g., flat, sharp), note relationships (e.g., tie, slur), and dynamics (e.g., pianissimo, forte). In some embodiments, a digital-print file including musical symbols can be formatted according to the Portable Document Format (PDF) standard. In some embodiments, a digital-print file including musical symbols can be formatted according to a digital image standard such as, for example, a Joint Photographic Experts Group (JPEG) standard or the Graphics Interchange Format (GIF).

In general, the mix of parameters in a digital audio file is more important than any individual parameter. To implement the methods described herein, the Intelligent Headphone 100 particularly analyzes one or more of the following characteristics for each musical composition: bandwidth, volume, tempo, rhythm, low frequency, noise, octave, and how these characteristics change over time, as well as length of the audio data. It is important to note that not all of the characteristics necessarily provide distinctions in the digital audio file.

In order to measure each of these characteristics, the digital audio file is divided into “chunks” which are separately processed in order to measure the characteristics for each such “chunk.”“

Chunk” size is fixed and selected for optimizing performance over a test sample of songs so as to provide an appropriately representative sample for each parameter of interest. Once the data from the digital audio file is divided into such “chunks,” the value for each parameter in each chunk is measured. Parameters are measured over all “chunks” and averaged.

Digital-audio files stored on the Back-End server 120 include audio information that can be used to playback sound on a speaker device. Digital-audio files can include a synthetic rendering of what the arrangement sounds like and/or an actual recording of music by one or more performers. In some embodiments, a digital-audio file can be formatted according to a Moving Picture Experts Group (MPEG) format (e.g., as an .MP3 file), a Waveform Audio File (WAY) format (e.g., as a .WAV file), a Musical Instrument Digital Interface (MIDI) message (e.g., as a .MID file), a MusicXML notation file format, and/or other audio file formats

In some embodiments, a particular song can be associated with one or more arrangements of sheet music (e.g., one or more types of arrangements such as a full-transcription or a guitar-vocal only transcription), in which case multiple digital-print files including the respective sheet music information can be stored on the Back-End server 120. Additional digital-print files can be stored on the Back-End Server 120 as digital preview files of other and separate digital-print file(s) (e.g., images of a selected set of one or more pages of the digital-print file(s)).

In additional embodiments, operators of the Back-End Server 120 can obtain digital sheet music rights for music from composers, music publishers, and/or other copyright owners, in which the composers/music publishers are allowed to submit compositions (e.g., audio files) for sheet music publishing to the Back-End Server 120 or other repository database. Based on the submitted audio recording(s) of the respective music, the operators of the Back-End Server 120 can have the digital sheet music transcribed through, for example, an open or closed network of music arrangers. In some embodiments, the audio recording(s) of the music can be stored on the Back-End Server 120 and made accessible via the Transmission medium 110 to selected arrangers. After the music has been transcribed, the arrangers can upload the sheet music as digital-print files back to the Back-End server 120 via the Transmission medium 110. Based on financial information for purchases recorded by the Back-End Server 120, revenue and proceeds can be reported to and divided among the appropriate parties (e.g., an arranger can receive a percentage of the sales of sheet music that they created, composers/music publishers can receive a percentage of the sales of sheet music that they licensed to the operators of the Back-End Server 120, operators of the Front-End servers 130 that referred purchases can receive a percentage of their referral sales)

### User Preference Analysis

The music cortex disclosed in the embodiments herein uses a series of complex artificial intelligence algorithms to analyze a plurality of (sonic) characteristics in a musical composition and its social features as well. The cortex is then able to sort any collection of digital music based on any combination of similar characteristics. The characteristics analyzed are those that produce the strongest reaction in terms of human perception and social popularity by data from other users, such as melody, tempo, rhythm, range, harmony, tonality, and tone color; and how these characteristics change over time.

In an alternate embodiment, the Intelligent Headphone 100 is secured by an anti-theft feature which is considered as a user-friendly way to disable and possibly locate the Intelligent Headphone 100 in the event of theft or loss. Any customer who purchases the Intelligent Headphone 100 will be entitled to a user account. This user account binds the user profile with the Intelligent Headphone 100 purchased by the customer. By using the mobile application, the user can trigger a change in state of the device to “lost/stolen”. Further, the client server technology of the present subject matter induces the back end of the system to incapacitate the Intelligent Headphone 100 to make it inoperable and effectively make it a paper weight.

The Music cortex system of the present subject matter forecasts the taste of an individual, preferably on the basis of a sample of musical selections which are rated by the user but alternatively on the basis of other information about the taste of the user. The Music cortex system also optionally uses one or more of the following: a feature base describing every musical item (e.g., song) in terms of a predefined set of musical features, a song map describing the closeness between the different musical items and a rating listing describing the popularity of those items, a social graph to describle the similarity from big user data. The items forecast to be preferred by the individual may then optionally be recommended for sale or for listening.

The music cortex gathers data of one or more types concerning the characteristic(s) of each song, and the relationship between these characteristic(s) and the perception of the listeners, or their musical taste. The Music cortex may then optionally be used to predict additional song(s) which may be of interest to the user. It should be noted that although the description centers around prediction and recommendation of songs (musical selections), in fact the present subject matter is also extensible to other interests of users which involve subject issues of “taste” for any type of media selection.

Based on the above description, it can be summarized that the Music cortex disclosed in the embodiments is a learning algorithm which learns user's preferences and then provides a continual refreshing playlist according to the wishlist of the user. The Music cortex is essentially a backend service that provides a “candidate list or wishlist” to clients.

### Exemplary System Architecture

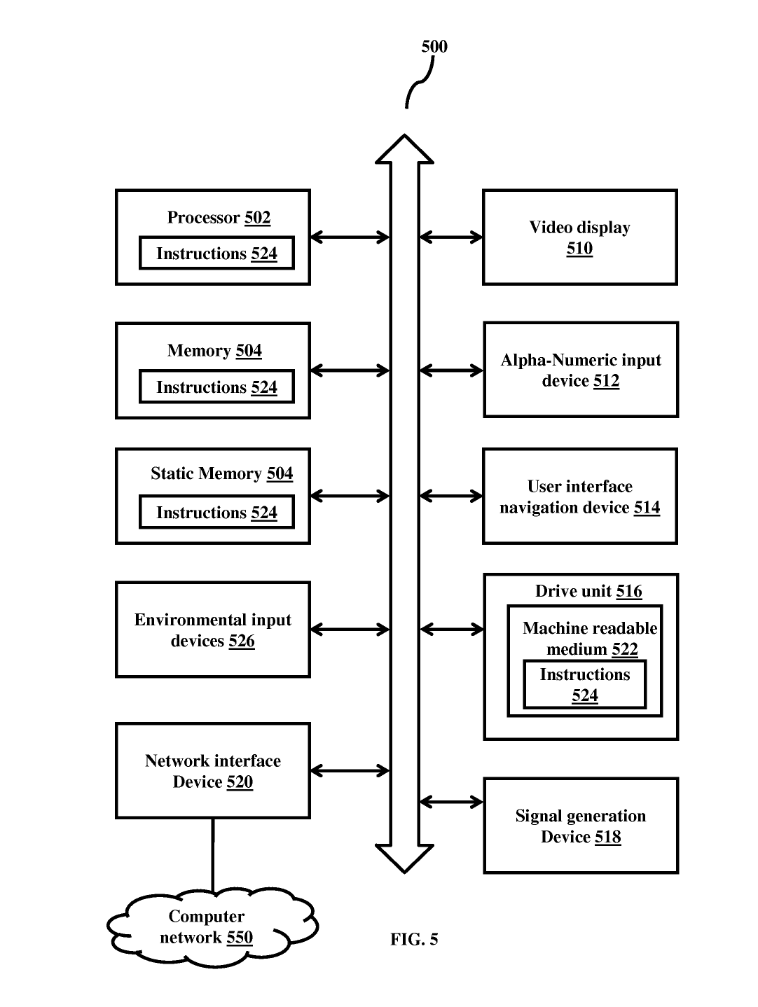

FIG. 5 is a block diagram of a machine in the example form of a computer system 500 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504, and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker), and a network interface device 520. The computer system 500 may also include a environmental input device 526 that may provide a number of inputs describing the environment in which the computer system 500 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions 524 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 524 may further be transmitted or received over a computer network 550 using a transmission medium. The instructions 524 may be transmitted using the network interface device 520 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other multimedia information can be passed between the computer and components (or steps) of a system using a wireless network based on a protocol, for example Wi-Fi (IEEE standards 802.11, 802.11a, 802.11b, 802.11e, 802.11g, 802.11i, and 1802.11n). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

What is claimed is:

1. A computer-implemented system for determining user preference for units of multimedia information, from within a library of units of multimedia information; the system comprising:
a user interface device for allowing a user to access the units of multimedia information, the device having a user reaction input for receiving indicia of favorable user reaction to the units of multimedia information;
a taxonomy module for classifying the units of multimedia information according to a predetermined set of classification parameters;
a user reaction correlation module for determining user preference of units of multimedia information based on the taxonomy module's classification of the units of multimedia information for which the indicia of favorable user reaction were received by the user reaction input;
wherein the user interface device also has an information selector, for selecting units of multimedia information based on correlation between the classification parameters of the units of multimedia information, and the classification parameters for which indicia of favorable user reactions have been received.

2. A computer-implemented system as recited in claim 1, further comprising an anti-theft feature module, said module configured to disable and locate the device, wherein a mobile application installed in the device triggers a change in the state of the device to at least one of lost or stolen.

3. A computer-implemented system as recited in claim 1, further comprising a communication network interface for communicating with a remote repository of units of multimedia information; whereby the system establishes communication with the remote repository for downloading selected ones of the units of multimedia information.

4. A computer-implemented system as recited in claim 3, wherein the user reaction correlation module employs the received indicia of favorable user reaction to infer, based on the taxonomy module's classification of the units of multimedia information, classifications of the units of multimedia information which are preferred by the user, whereby the downloading selected ones of the units of multimedia information is performed for ones of the units of multimedia information that are selected from the preferred classifications thereof.

5. A computer-implemented system as recited in claim 1, wherein the classification parameters employed by the taxonomy module to classify the units of multimedia information are based on feature vectors.

6. A computer-implemented system as recited in claim 5, wherein the feature vectors include elements which are one of (i) numeric values, (ii) mean/standard deviation measures of statistic distance between social clusters, and (iii) non-numeric values selected from a set of possibilities.

7. A computer-implemented system as recited in claim 6, wherein the feature vectors include one of (i) statistical measures of short time, frame based features across long term windows, (ii) measures describing the rhythmic properties of the excerpt, and (iii) social feature data from other users which may be compared and correlated with the user's preferences.

8. A computer-implemented system as recited in claim 1, wherein:
the units of multimedia information include (i) audio information including one of music, speech, and sound effects; and (ii) visual information including one of video, still images, graphics, and displayed text or other symbols; and
the classification parameters for the audio information include one of (i) categories of music genre, (ii) musicians including one of instrumental or vocal artists; (iii) music theory concepts, and (iv) social similarity clustering from analysis of preference data from other users.

9. A computer-implemented system as recited in claim 3, wherein the system establishes communication with the remote repository through the communication network interface for downloading selected ones of the units of multimedia information from the remote repository of units of multimedia information, based on correlation of the units of multimedia information to be downloaded with the user preference.

10. A computer-implemented system as recited in claim 3, wherein the system establishes communication with the remote repository through the communication network interface at times when (i) communication over the communication network is available, and (ii) the system is not otherwise occupied providing downloaded units of multimedia information to the user.

11. A computer-implemented method for determining user preference for units of multimedia information, from within a library of units of multimedia information; the method comprising:
accessing the units of multimedia information for playback to the user by an audio output;
receiving indicia of favorable user reaction to the units of multimedia information through a user input interface;
classifying the units of multimedia information according to a predetermined set of classification parameters;
determining user preference of units of multimedia information based on the classification of the units of multimedia information for which the indicia of favorable user reaction were received; and
selecting units of multimedia information based on correlation between the classification parameters of the units of multimedia information, and the classification parameters for which indicia of favorable user reactions have been received.

12. A computer-implemented method as recited in claim 11, further comprising communicating with a remote repository of units of multimedia information; and establishing communication with the remote repository for downloading selected ones of the units of multimedia information, by employs the received indicia of favorable user reaction to infer, based on the classification of the units of multimedia information, classifications of the units of multimedia information which are preferred by the user, whereby the downloading selected ones of the units of multimedia information is performed for ones of the units of multimedia information that are selected from the preferred classifications thereof.

13. A computer-implemented method as recited in claim 11, wherein the classification parameters employed to classify the units of multimedia information are based on feature vectors including elements which are one of (i) numeric values, (ii) mean/standard deviation measures of statistic distance between social clusters, and (iii) non-numeric values selected from a set of possibilities.

14. A computer-implemented method as recited in claim 13, wherein the feature vectors include one of (i) statistical measures of short time, frame based features across long term windows, (ii) measures describing the rhythmic properties of the excerpt, and (iii) social feature data from other users which may be compared and correlated with the user's preferences.

15. A computer-implemented method as recited in claim 11, wherein:
the units of multimedia information include (i) audio information including one of music, speech, and sound effects; and (ii) visual information including one of video, still images, graphics, and displayed text or other symbols; and
the classification parameters for the audio information include one of (i) categories of music genre, (ii) musicians including one of instrumental or vocal artists; (iii) music theory concepts, and (iv) social similarity clustering from analysis of preference data from other users.

16. A computer program product for determining user preference for units of multimedia information, from within a library of units of multimedia information; the computer program product comprising:
a non-transitory computer-readable medium; and
computer software program code, provided on the non-transitory computer-readable medium, for directing a computer-implemented user playback, input and network communication apparatus to perform the actions of:
accessing the units of multimedia information for playback to the user by an audio output;
receiving indicia of favorable user reaction to the units of multimedia information through a user input interface;
classifying the units of multimedia information according to a predetermined set of classification parameters;
determining user preference of units of multimedia information based on the classification of the units of multimedia information for which the indicia of favorable user reaction were received; and
selecting units of multimedia information based on correlation between the classification parameters of the units of multimedia information, and the classification parameters for which indicia of favorable user reactions have been received.

17. A computer program product as recited in claim 16, further comprising communicating with a remote repository of units of multimedia information; and establishing communication with the remote repository for downloading selected ones of the units of multimedia information, by employs the received indicia of favorable user reaction to infer, based on the classification of the units of multimedia information, classifications of the units of multimedia information which are preferred by the user, whereby the downloading selected ones of the units of multimedia information is performed for ones of the units of multimedia information that are selected from the preferred classifications thereof.

18. A computer program product as recited in claim 16, wherein the classification parameters employed to classify the units of multimedia information are based on feature vectors including elements which are one of (i) numeric values, (ii) mean/standard deviation measures of statistic distance between social clusters, and (iii) non-numeric values selected from a set of possibilities.

19. A computer program product as recited in claim 18, wherein the feature vectors include one of (i) statistical measures of short time, frame based features across long term windows, (ii) measures describing the rhythmic properties of the excerpt, and (iii) social feature data from other users which may be compared and correlated with the user's preferences.

20. A computer program product as recited in claim 16, wherein:
the units of multimedia information include (i) audio information including one of music, speech, and sound effects; and (ii) visual information including one of video, still images, graphics, and displayed text or other symbols; and
the classification parameters for the audio information include one of (i) categories of music genre, (ii) musicians including one of instrumental or vocal artists; (iii) music theory concepts, and (iv) social similarity clustering from analysis of preference data from other users.
